(19) United States
(12) Patent Application Publication
(10) Pub. No.: US 2009/0267896 A1
(43) Pub. Date: Oct. 29, 2009

(54) INPUT DEVICE

(76) Inventor: Ryosuke HIRAMATSU, Fujisawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/343,002

(22) Filed: Dec. 23, 2008

(30) Foreign Application Priority Data
Apr. 28, 2008 (JP) P2008-117329

(51) Int. Cl. G09G 5/08

(52) U.S. Cl. 345/157

(57) ABSTRACT

According to one embodiment, an input device includes: a sensor part configured to detect a hand-writing operation; an input recognition part configured to recognize a content from the writing operation detected by the sensor part; a storage part configured to store a conversion command database in which to associate the content with a command; and a conversion output part configured to output the command based on the conversion command database and the content.

### CROSS-REFERENCE TO RELATED APPLICATIONS

This application is based upon and claims the benefit of priority from Japanese Patent Application No. 2008-117329, filed Apr. 28, 2008, the entire contents of which are incorporated herein by reference.

### BACKGROUND

1. Field

The present invention relates to an input device.

2. Description of the Related Art

As a prior art, there is an input device that judges the orientation of a pen, the user who inputs, and the input content with a pressure sensor in a pen grip portion and a built-in gyro sensor (e.g., refer to JP-A-10-198509).

This input device has an outer shape of pen type, and comprises a pressure sensor provided in a pen grip portion grasped by the fingers of the user, a gyro sensor provided within a main body, a storage part for storing user information and a user dictionary, and a control part that operates as a user identification part and an input content discrimination part, in which the user identification part of the control part judges the user based on a pressure distribution detected by the pressure sensor, and selects the user information and the user dictionary from the judgment result, and the input content discrimination part makes the pattern recognition for the writing operation detected by the pressure sensor and the gyro sensor, so that the input content based on the writing operation can be correctly judged in accordance with the user.

However, with the conventional input device, though the character can be inputted through the pattern recognition for the writing operation, other operation than the input of character information is not considered. Also, the writing operation for other than the characters registered in the user dictionary is not recognized.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic view showing the appearance of an input device according to an embodiment of the present invention.

FIG. 2 is an exemplary block diagram showing a configuration example of the input device according to the embodiment of the invention.

FIG. 3A is an exemplary schematic view showing a writing operation example of the input device according to the embodiment of the invention.

FIG. 3B is an exemplary schematic view showing a writing operation example of the input device according to the embodiment of the invention.

FIG. 4 is an exemplary schematic view showing one example of a fingerprint of the user recognized on a pressure sensor part of the input device according to the embodiment of the invention.

FIGS. 5A and 5B are exemplary schematic views showing the pressure characteristics and a corresponding example of an input character recognized on the pressure sensor part of the input device according to the embodiment of the invention.

FIG. 6 is an exemplary schematic view showing the corresponding examples of the input content and the output command for the input device according to the embodiment of the invention.

FIG. 7 is an exemplary flowchart showing the operation of the input device according to the embodiment of the invention.

### DETAILED DESCRIPTION

Various embodiments according to the invention will be described hereinafter with reference to the accompanying drawings. In general, according to one embodiment of the invention, there is provided an input device including: a sensor part configured to detect a hand-writing operation; an input recognition part configured to recognize a content from the writing operation detected by the sensor part; a storage part configured to store a conversion command database in which to associate the content with a command; and a conversion output part configured to output the command based on the conversion command database and the content.

The embodiments of an input device according to the present invention will be described below in detail with reference to the drawings.

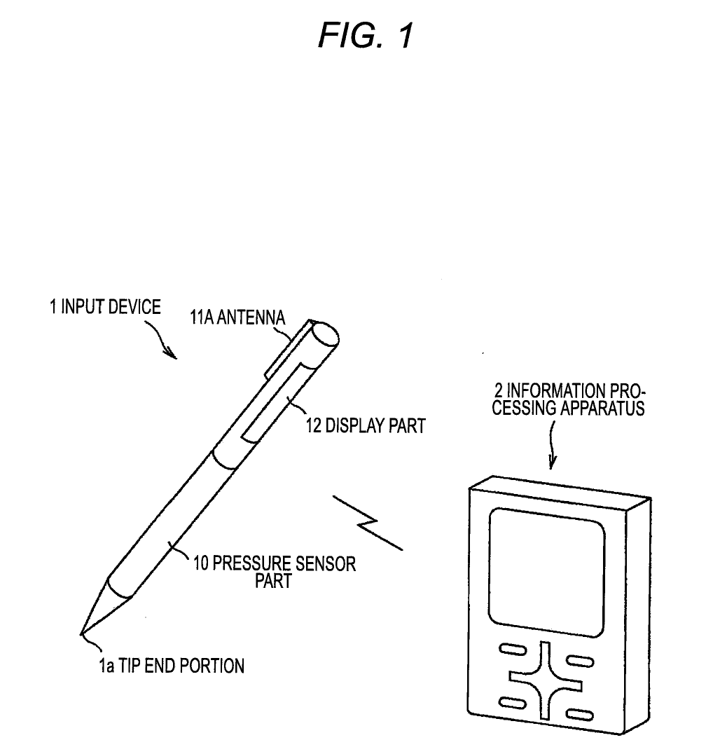

FIG. 1 is a schematic view showing the appearance of an input device according to an embodiment of the invention.

The input device 1 has an outer shape of pen type having a pointed tip end portion 1a, in which if a writing operation is performed by the user, the input content is recognized by a pressure sensor part 10 disposed in a grip portion and displayed on a display part 12. Also, the input device 1 contains a wireless communication part such as a wireless LAN (Local Area Network) module, for example, and can communicate via an antenna 11A with an information processing apparatus 2 to transmit the input content, and the information processing apparatus 2 performs the character input, the reproduction or suspension of a voice file, and the switching of a television broadcasting channel, based on the received input content.

The pressure sensor part 10 has a lower electrode provided on a flexible substrate and an upper electrode provided on a film, for example, in which the lower electrode and the upper electrode are opposed via an air layer to form a condenser. A pressure sensor element composed of a pair of the lower electrode and the upper electrode is arranged at a resolution of about 500 dpi to detect a pressure distribution, and detect a fingerprint of grasping finger.

(Configuration of Input Device)

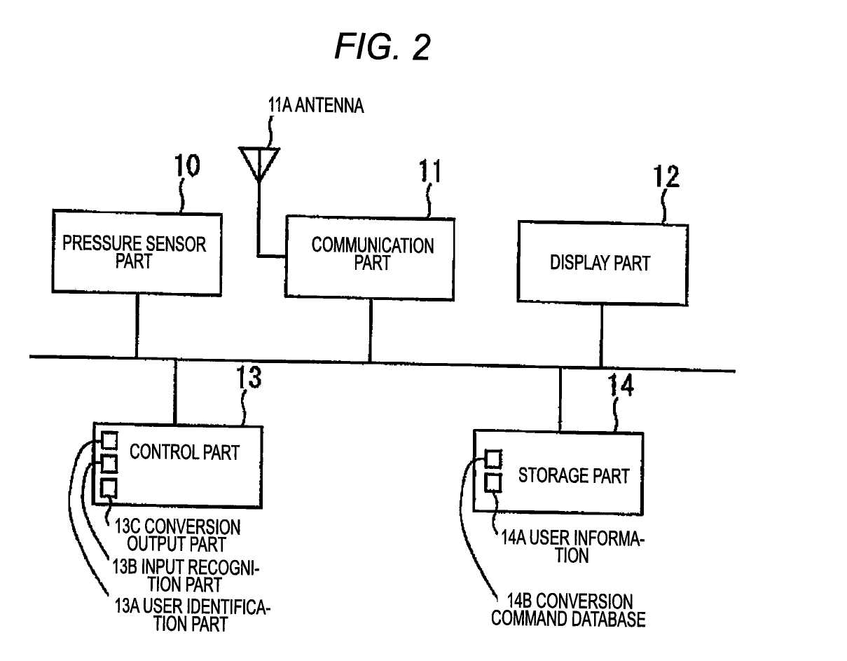

FIG. 2 is a block diagram showing a configuration example of the input device according to the embodiment of the invention.

The input device 1 has the pressure sensor part 10, composed of a plurality of pressure sensor elements, for detecting the pressure distribution, the communication part 11 for making the wireless communication with an external apparatus via the antenna 11A in conformance to the communication standards for the wireless LAN or the like, the display part 12 composed of a small liquid crystal display panel for displaying the input content or the like inputted through the writing operation, a control part 13 for controlling the operation of each part within the input device 1, and a storage part 14 such as a non-volatile flash memory or the like for storing information in readable and writable manner.

The control part 13 has a user identification part 13A for identifying the user, based on the fingerprint of the user detected by the pressure sensor part 10, an input recognition part 13B for discriminating the input content based on the output of the pressure sensor part 10 through the writing operation, and a conversion output part 13C for converting the input content discriminated by the input recognition part 13B into a command based on a conversion command database 14B, as will be described later.

The storage part 14 has user information 14A that associates the fingerprint detected on the pressure sensor part 10 and the user, and the conversion command database 14B that associates the input content discriminated on the input recognition part 13B and the predefined command for each user. Also, the conversion command database 14B is prepared for each user and associated with the user information 14A. Also, the conversion command database 14B can be rewritten by the user.

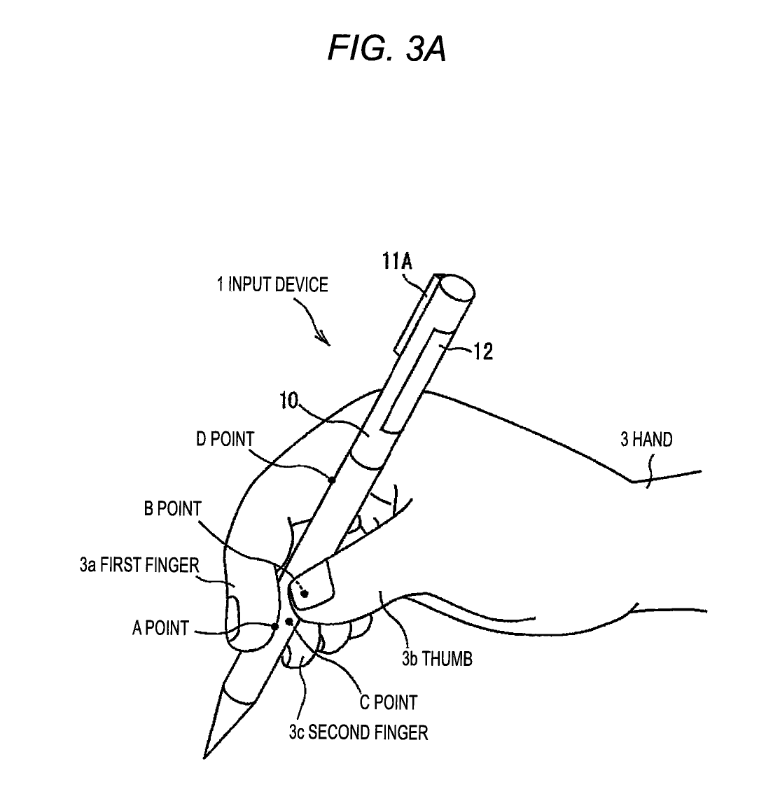

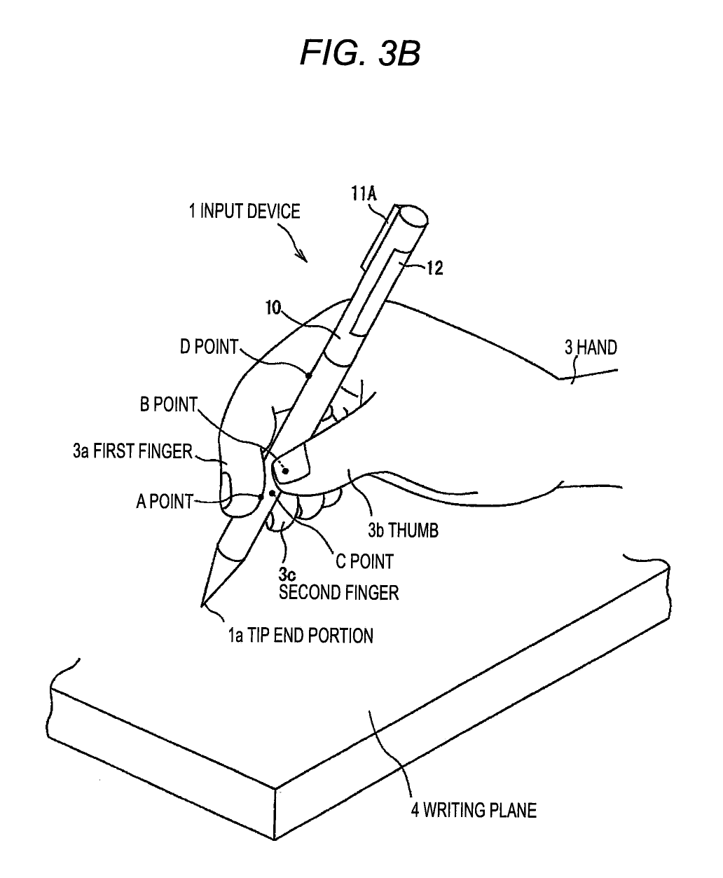

FIG. 3A is a schematic view showing a writing operation example of the input device according to the embodiment of the invention.

The input device 1 is grasped by a hand 3 of the user, typically at the A point on the tip of a first finger 3a, B point on the tip of a thumb 3b, C point on the lateral face of a second finger 3c, and D point on the basipodite of the first finger 3a. The pressure sensor part 10 detects the pressure at each of A point to D point. The start of the writing operation is judged from the pressure characteristics at A point to D point by the input recognition part 13B.

FIG. 3B is a schematic view showing a writing operation example of the input device according to the embodiment of the invention.

Besides an input method of FIG. 3A, the input device 1 may be grasped by the hand 3 of the user, the pressure sensor part 10 may detect the pressure at each of A point to D point, and the input recognition part 13B may judge the start of the writing operation depending on whether the tip end portion 1a contacts a writing plane 4.

As described above, the writing operation in the invention is not limited to the writing operation on the writing plane 4 as shown in FIG. 3B, but includes the writing operation performed three-dimensionally in the air as shown in FIG. 3A. Also, the writing content corresponding to the writing operation is not limited to the character or symbol, but may be any handwriting as far as the pressure sensor part 10 can detect a temporal change in the pressure.

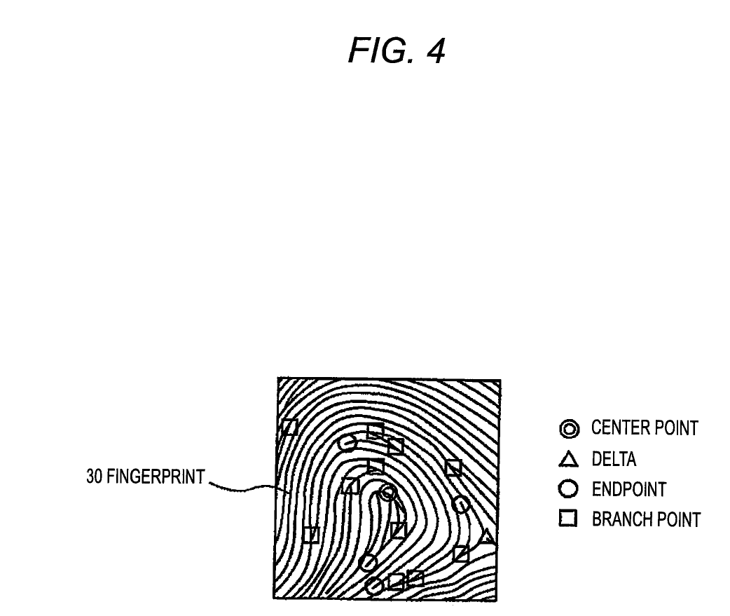

FIG. 4 is a schematic view showing one example of a fingerprint of the user recognized on the pressure sensor part of the input device according to the embodiment of the invention.

The fingerprint 30 is recognized by a plurality of pressure sensor elements in the pressure sensor part 10. The user identification part 13A identifies the user by analyzing the fingerprint 30 to detect the center point, delta, endpoint, branch point and so on, and making the comparison with the user information 14A. Also, the input recognition part 13B detects the inclination and orientation of the pen from the positional relationship of the center point, delta, endpoint and branch point of the fingerprint 30.

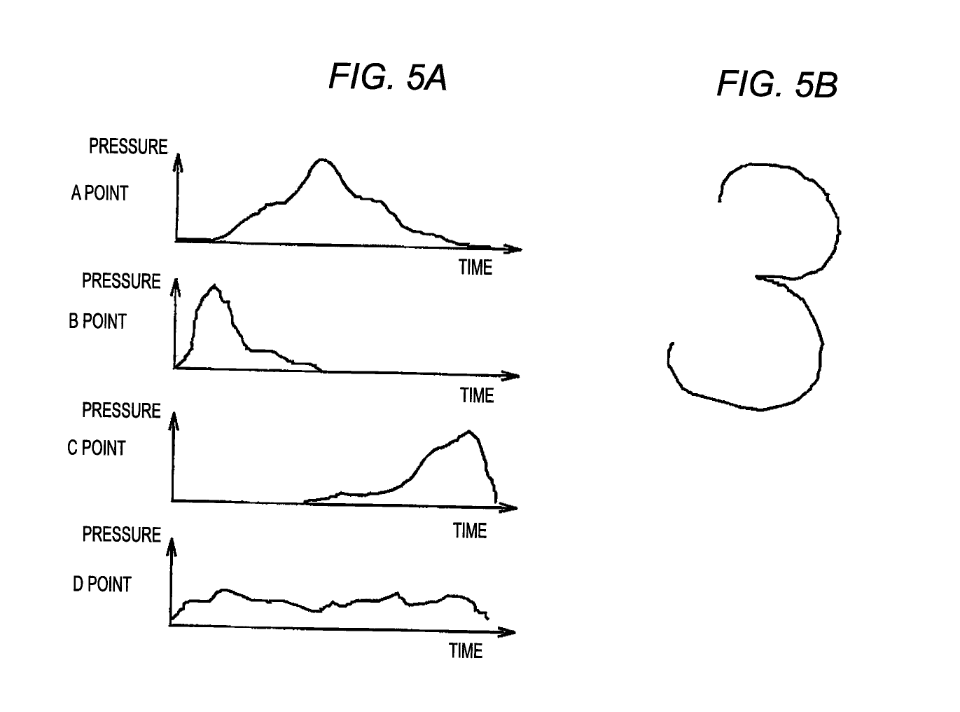

FIGS. 5A and 5B are schematic views showing the pressure characteristics and a corresponding example of the input character recognized on the pressure sensor part of the input device according to the embodiment of the invention.

The pressures at A point to D point as shown in FIG. 3 are detected independently by the pressure sensor part 10, and for example, detected as the temporal changes, as shown in FIG. 5A. The input recognition part 13B discriminates the input content as shown in FIG. 5B from a combination of pressure changes at A point to D point. It is supposed that a database for discriminating the input content is included in the user information 14A.

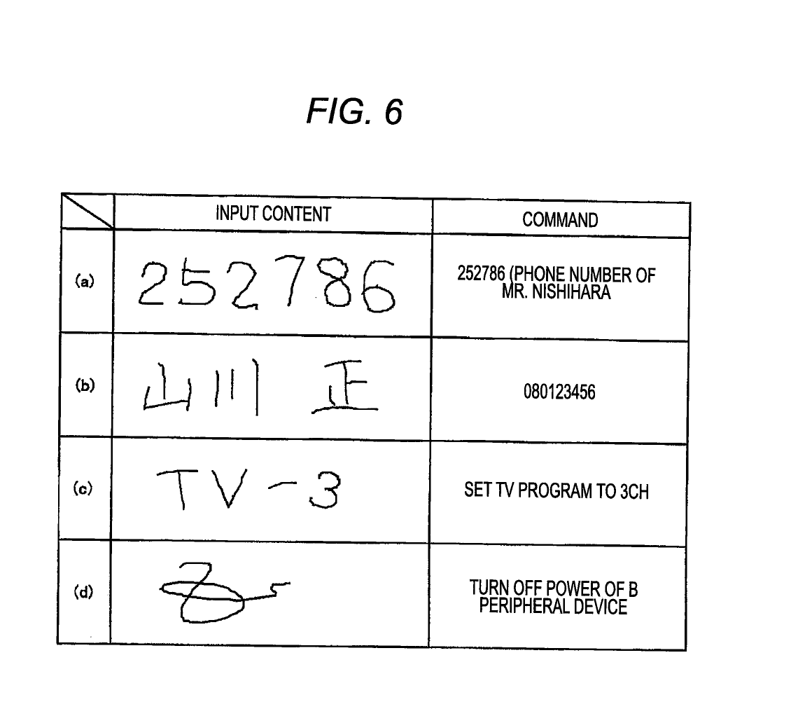

FIG. 6 is a schematic view showing the corresponding examples of the input contents and the output commands for the input device according to the embodiment of the invention.

The conversion command database 14B associates the input content with the output command. For example, in the case where the input content is “252786” as shown in FIG. 6A, the command of “252786 (telephone for Mr. Nishihara)” is associated. Also, in the case where the input content is “Yamakawa Tadashi” as shown in FIG. 6B, the command of telephone number like “080123456” is associated. Also, in the case where the input content is “TV-3” as shown in FIG. 6C, the command of setting television program at channel 3ch on the television received by the information processing apparatus 2 is associated. Also, in the case where the input content is a personal signature, as shown in FIG. 6D, the command of turning off the power of a peripheral device B, not shown, is associated.

(Operation)

The operation of the input device according to the embodiment of the invention will be described below with reference to the drawings.

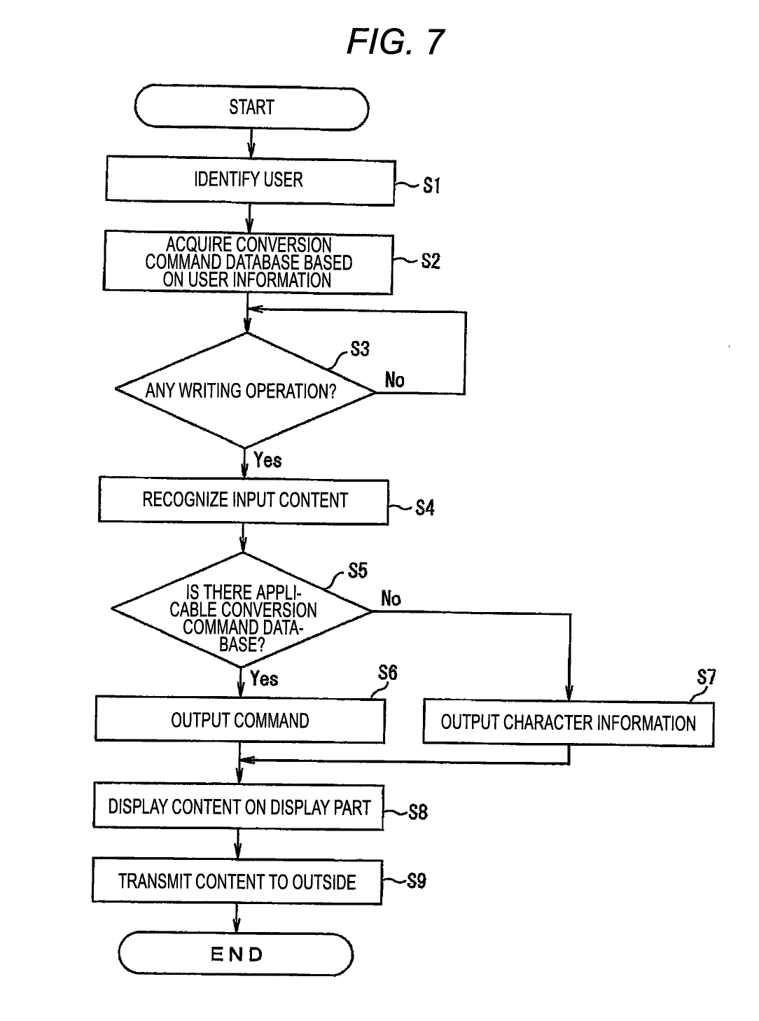

FIG. 7 is a flowchart showing the operation of the input device according to the embodiment of the invention.

First of all, the user identification part 13A identifies the user by detecting the fingerprint 30 and acquires the user information 14A, when the user touches the pressure sensor part 10 (S1). Then, the conversion command database 14B associated with the user is acquired based on the user information 14A (S2).

If the writing operation is performed by the user (S3: Yes), the input recognition part recognizes the input content by acquiring the pressure changes at A point to D point in the pressure sensor part 10 (S4). The conversion output part 13C checks whether or not the input content recognized by the input recognition part 13B exists in the conversion command database 14B (S5).

If the input content exists in the conversion command database 14B (S5: Yes), the conversion output part 13C outputs the command based on the conversion command database 14B (S6). Also, if the input content does not exist in the conversion command database 14B (S5: No), the input content is converted into character information such as text data for output (S7).

The command or character information outputted at step S6 or S7 is displayed on the display part 12 (S8), and transmitted via the communication part 11 and the antenna 11A to the external apparatus, for example, the information processing apparatus 2 (S9).

(Effects of the Embodiment)

With the above embodiment, since the input device 1 has the conversion command database 14B for converting the input content into the command, various kinds of information other than character information can be inputted through the writing operation. Also, since the user is identified by acquiring the fingerprint 30, and the conversion command database 14B prepared for each user is acquired, the command conversion can be performed according to the intent of the user.

Since the personal signature that does not exist in the character code is recognized and converted into the command, the writing operation can be performed without the content of command being known to others person than the user.

The user identification may be made by a method of vein authentication, iris authentication or face authentication, and the method is not limited. A gyro sensor or an acceleration sensor may be also used for detecting the start of the writing operation.

Also, the external apparatus is not limited to the information processing apparatus 2, but a plurality of external apparatuses may be connected at the same time. Also, the communication may be made via an access point and the internet to control the external apparatus at the remote site.

Also, the conversion command database 14B may be provided with a learning function part and rewritten by learning from statistical information of the input content of the user.

As described with reference to the embodiment, there is provided an input device that inputs various kinds of information through the writing operation of the user.

What is claimed is:

1. An input device comprising:
a sensor part configured to detect a hand-writing operation;
an input recognition part configured to recognize a content from the writing operation detected by the sensor part;
a storage part configured to store a conversion command database in which to associate the content with a command; and
a conversion output part configured to output the command based on the conversion command database and the content.

2. An input device comprising:
a sensor part configured to detect user specific information and a hand-writing operation;
a storage part configured to store user information for identifying a user and a conversion command database in which to associate a content and a command for each user;
a user identification part configured to identify the user from the user specific information detected by the sensor part to acquire the user information corresponding to the identified user and to refer the conversion command database based on the acquired user information;
an input recognition part configured to recognize the content from the hand-writing operation detected by the sensor part; and
a conversion output part configured to output a command based on the conversion command database and the content.

3. The input device according to claim 2, wherein the sensor part comprises a pressure sensor, and
wherein the user identification part acquires a fingerprint from the user as the user specific information.

4. The input device according to claim 2, wherein the conversion output part outputs the content as text data when the corresponding content is not identified in the conversion command database.

5. The input device according to claim 2 further comprising a communication part configured to communicate with an external apparatus,
wherein the conversion output part outputs the command via the communication part to the external apparatus.

6. The input device according to claim 2, wherein the conversion command database is updatable by the conversion output part based on an operation of the user.

7. The input device according to claim 2, wherein the conversion command database is updatable by the conversion output part based on statistical information of an operation history of the user.
